(19) United States
(12) Patent Application Publication
(10) Pub. No.: US 2008/0116745 A1
(43) Pub. Date: May 22, 2008

(54) Apparatus for providing power and network signal from powerline network

(75) Inventors: Yu-Tsung Chang, Miaoli (TW); Wen-Tai Lin, Miaoli (TW)

Correspondence Address: BACON & THOMAS, PLLC, 625 SLATERS LANE, FOURTH FLOOR, ALEXANDRIA, VA, 22314, US

(73) Assignee: AboCom Systems, Inc., Miaoli (TW)

(21) Appl. No.: 11/652,635

(22) Filed: Jan. 12, 2007

(30) Foreign Application Priority Data
Nov. 21, 2006 (TW) 95220529

(51) Int. Cl. H02J 4/00

(52) U.S. Cl. 307/3

(57) ABSTRACT

An apparatus for providing power and network signal from a powerline network includes: a power component to connect the powerline network; a power unit electrically connected to the power component; a PoE module electrically connected to the power unit and a connecting port, so as to provide the power from the power unit for network power; and a network communication module electrically connected to the power component, the power unit and the PoE module, to access a network signal from the power component and integrate the PoE module, which providing power to the connecting port.

### BACKGROUND OF THE INVENTION

1. Field of the Invention

The present invention relates to a powerline apparatus, and more especially, to the apparatus for providing power and network signal from powerline network by integrating the technology of Powerline Communication (PLC) and Power Over Ethernet (PoE).

2. Background of the Related Art

The technology of Powerline Communication (PLC) is a kind of the communication technology in which the data and the voice signal are transmitted by the powerline. The value of using powerline to transmit data is more and more important because the powerline has the characteristics of wide distribution areas and easily connection. Users who use the powerline networking technology can get the network signal through the powerline network by electrically connecting a powerline networking apparatus with the socket.

As shown in FIG. 1, a general powerline networking apparatus 10 includes a power unit 12, a powerline-signal coupling unit 14, a signal processing unit 16, an Ethernet access unit 18, an Ethernet transformer 19 and a network connecting port 20. Wherein, the power unit 12 and the powerline-signal coupling unit 14 are electrically connected to one end of a power cord 22, and a plug (not shown in FIG. 1 ) is configured on the other end of the power cord 22. The plug is electrically connected to the powerline network, which preexists in the socket 24, to make the power unit 12 be able of supplying operation power to the whole powerline networking apparatus 10. Furthermore, the signal processing unit 16 accesses the network signal from the alternating voltage of the power cord 22 by means of the powerline-signal coupling unit 14. The Ethernet access unit 18 is electrically connected to the signal processing unit 16 and electrically connected to the network connecting port 20 via the Ethernet transformer 19, wherein the network connecting port 20 is configured to electrically connect to a network apparatus, such as the WebCam for monitoring.

The network apparatus can process the data transmission through the powerline network by using the foregoing powerline networking apparatus, however, the network apparatus, such as WebCam also needs another power cord to electrically connected to the socket, in order to obtain the operation power. Therefore, when the WebCam is increasingly needful, the sockets are not enough to supply for the power cords of the WebCams, and so as to have the disadvantage of not facile.

A Power Over Ethernet (PoE) technology is presently applied to transmit the direct current by the network cable, hence, the preexist network cable not only transmits the data, but also plays the role of power cord to transmit the power to the network apparatus connected with the network cable. Therefore, how to apply the PoE technology to the powerline networking apparatus is a technologic characteristic of the present invention.

### SUMMARY OF THE INVENTION

In order to solve the forgoing problems, one object of this invention is to provide an apparatus for providing power and network signal from a powerline network, wherein the network power is transmitted together with the network signal to a network apparatus by a PoE module.

One object of this invention is to provide an apparatus for providing power and the network communication simultaneously by only the single power cord or plug electrically connected to the powerline network, and comparing with the conventional design in that the additional power components and sockets are required by the network apparatus, the present invention has the advantages of use easily.

One object of this invention is to provide an apparatus for providing power and network signal from a powerline network, which is integrated and configured within a shell, to facilitate the carry to have the advantage of high practicability.

Accordingly, one embodiment of the present invention provides an apparatus for providing power and network signal from a powerline network, which includes: a power component configured to electrically connect to a powerline network; a power unit electrically connected to the power component; a connecting port configured to electrically connect to a network apparatus; a PoE module electrically connected to the power unit and the connecting port, to get power from the power unit into a network power; and a network communication module electrically connected to the power component and the power unit, to access a network signal from the power component and transmit the network signal to the connecting port.

### BRIEF DESCRIPTION OF THE DRAWINGS

FIG. 1 is a schematically block diagram illustrating a conventional powerline networking apparatus;

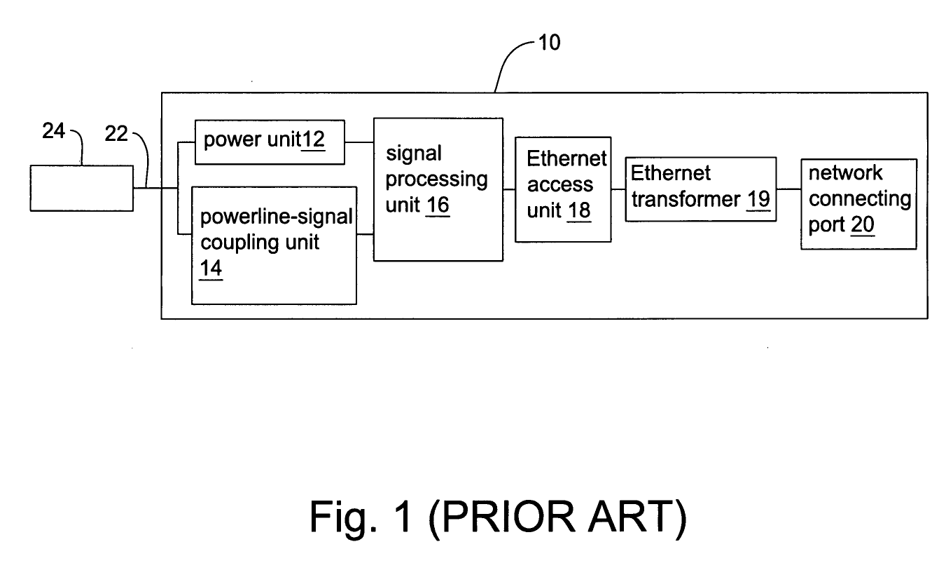

FIG. 2 is a schematically block diagram illustrating an apparatus for providing power and network signal from a powerline network in accordance with an embodiment of the present invention; and

FIG. 3 is a schematically block diagram illustrating an apparatus for providing power and network signal from a powerline network in accordance with another embodiment of the present invention.

### DETAILED DESCRIPTION OF THE INVENTION

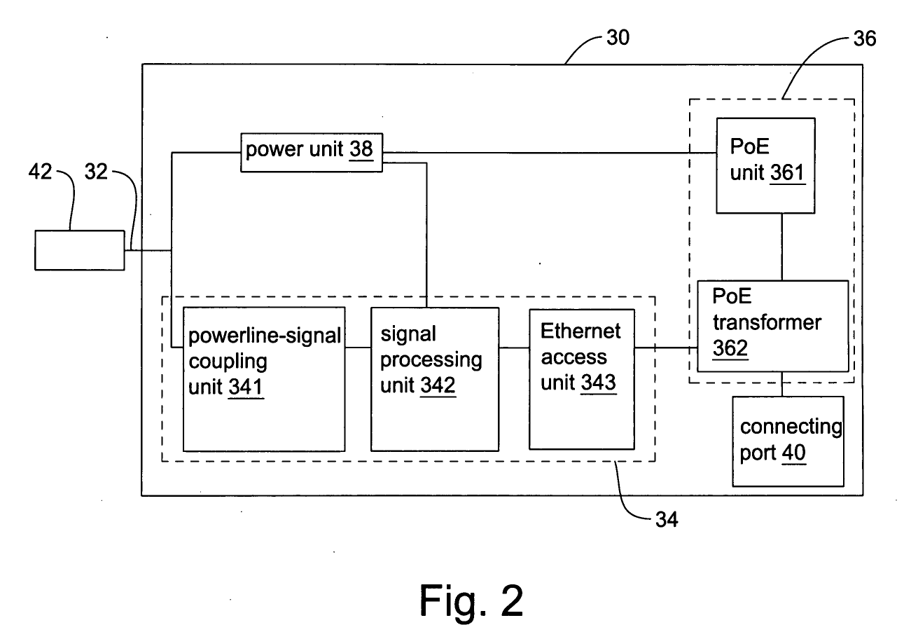

As shown in FIG. 2, it is a schematically block diagram illustrating an apparatus for providing power and network signal from a powerline network in accordance with an embodiment of the present invention. In the present embodiment, an apparatus for providing power and network signal from a powerline network 30 includes a power component 32, a network communication module 34, a PoE module 36, a power unit 38 and a connecting port 40 configured to electrically connect to a network apparatus (not shown in FIG. 2). The power component 32 is a power cord or an electric plug, wherein a plug (not shown in FIG. 2) configured on one end of the power cord is put into a socket 42 to electrically connect to a powerline network, which preexists in the socket 42 and is an alternating current powerline in general. The power unit 38 is electrically connected to the other end of the power component 32 to supply the operation power to the apparatus for providing power and network signal from a powerline network 30. The PoE module 36 is electrically connected to the power unit 38 and the connecting port 40 to transform a power from the power unit 38 into a network power.

The network communication module 34 includes a powerline-signal coupling unit 341, a signal processing unit 342 and an Ethernet access unit 343, wherein the powerline-signal coupling unit 341 is electrically connected to the power component 32, and the signal processing unit 342 is electrically connected to the powerline-signal coupling unit 341 and the Ethernet access unit 343, in order to make the signal processing unit 342 access the network signal from the alternating voltage of the power component 32 by means of the powerline-signal coupling unit 341, transform the network signal into a readable network signal for the network apparatus and then transmit the network signal to the PoE module 36 by means of the Ethernet access unit 343. The signal processing unit 342 is also used to transform an apparatus signal which comes from the network apparatus and is received by the Ethernet access unit 343 into the network signal and then transmit the network signal to the alternating voltage by the means of the powerline-signal coupling unit 341.

Continuously, the PoE module 36 includes a PoE unit 361 electrically connected to the power unit 38, and a PoE transformer 362 electrically connected to the PoE unit 361, the Ethernet access unit 343 and the connecting port 40. The PoE unit 361 is used to obtain the power from the power unit 38 and provide the power to the PoE transformer 362. At the same time, the PoE transformer 362 also receives the network signal from the Ethernet access unit 343 and then integrates the network signal with the network power. The integrated network signal is then transmitted to the network apparatus.

In one embodiment, the foregoing network communication module 34, PoE module 36, power unit 38 and connecting port 40 are integrated and configured within a shell (not shown in FIG. 2), wherein the powerline-signal coupling unit 341 is a coupling transformer. The designs of the PoE unit 361 and the PoE transformer 362 correspond to an IEEE 802.11af standard and the network power transformed by the PoE transformer 362 is a direct current (D.C.) with 48 volts. Furthermore, the connecting port 40 is any connector, such as the RJ45 port, which generally includes a data receiving pair, a data transmitting pair and two spare pairs. In the foregoing embodiment, the data receiving pair and the data transmitting pair are used to transmit the network signal, which comes from the integration of the network signal with the network power by the PoE transformer 362.

On the other hand, in the present embodiment, the network signal and the network power do not need to be combined by the PoE transformer, because the RJ45 port has two spare pairs, which can be directly used to transmit the network power, simultaneously, the data receiving pair and the data transmitting pair are used to transmit the network signal.

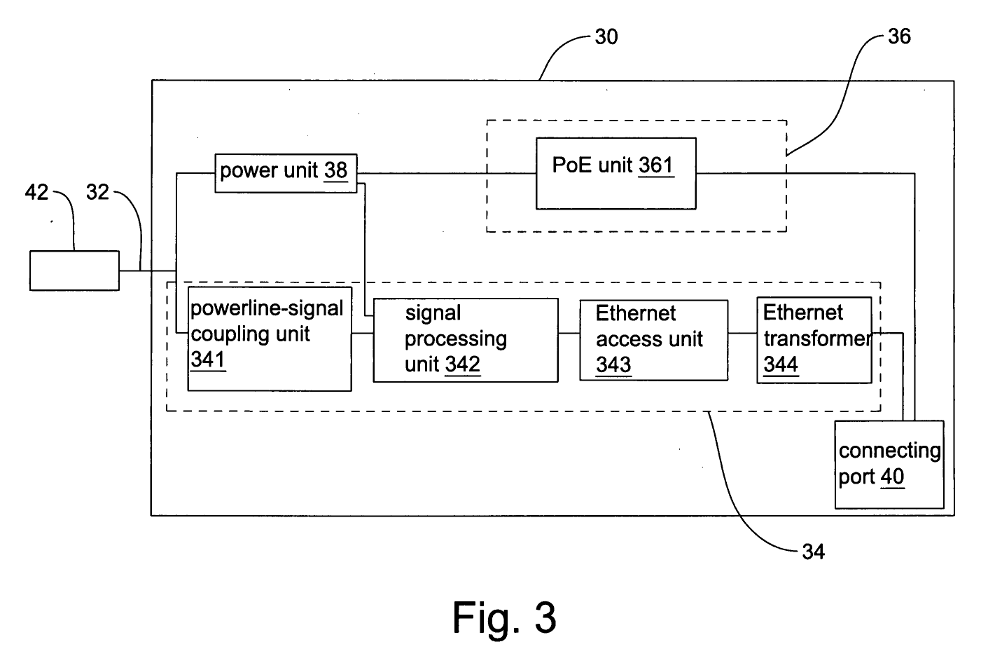

Besides, in the present invention, the PoE transformer can be omitted from the PoE module 36 and the PoE unit 361 is directly and electrically connected to the power unit 38 and the connecting port 40. As shown in FIG. 3, the PoE unit 361 is used to obtain the power from the power unit 38 and transform the power into the network power which is a direct current, and then the network power is output to the connecting port 40 and further output to the network apparatus. Furthermore, the network communication module 34 further includes an Ethernet transformer 344 electrically connecting to the Ethernet access unit 343 to process the network signal and the apparatus signal accessed by the Ethernet access unit 343.

To sum up, in the apparatus for providing power and network signal from a powerline network, one end of the electrical component is inserted into the socket to electrically connect to the powerline network to obtain the power and the network signal. The PoE module is used to provide the operation power to the network apparatus. Compared with the conventional design, in that the additional power components and sockets are required by the network apparatus which is connected with the powerline network, the operation of the network apparatus and the network communication in the present invention are achieved simultaneously by only the single power component electrically connected to the powerline network. Therefore, the present invention not only has the advantages of use easily, but also can decrease the cost of the additional power component and the socket. On the other hand, because the foregoing network communication module, the PoE module, power unit and connecting port are integrated and configured within a shell, the carry of the apparatus for providing power and network signal from a powerline network is quite convenient to have the advantage of high practicability and user friendly.

Although the present invention has been explained in relation to its preferred embodiment, it is to be understood that other modifications and variation can be made without departing the spirit and scope of the invention as hereafter claimed.

What is claimed is:

1. An apparatus for providing power and network signal from a powerline network, comprising:
a power component configured to electrically connect to a powerline network;
a power unit electrically connected to said power component;
a connecting port configured to electrically connect to a network apparatus;
a power over Ethernet module electrically connected to said power unit and said connecting port, to transform a power from said power unit into a network power; and
a network communication module electrically connected to said power component and said power unit, to access a network signal from said power component and transmit said network signal to said connecting port.

2. An apparatus for providing power and network signal from a powerline network according to claim 1, wherein said network communication module comprises:
a powerline-signal coupling unit electrically connected to said power component;
a signal processing unit electrically connected to said powerline-signal coupling unit, to access and process said network signal; and
an Ethernet access unit electrically connected to said signal processing unit, to receive said network signal and transmit said network signal to said power over Ethernet module, and to receive an apparatus signal from said network apparatus and transmit said apparatus signal to said signal processing unit, wherein said power over Ethernet module is used to integrate said network signal with said network power, which is then transmitted to said connecting port.

3. An apparatus for providing power and network signal from a powerline network according to claim 2, wherein said power over Ethernet module comprises:
a power over Ethernet unit electrically connected to said power unit to obtain said power from said power unit; and
a power over Ethernet transformer electrically connected to said power over Ethernet unit and said network communication module, and used to integrate said network signal with said network power.

4. An apparatus for providing power and network signal from a powerline network according to claim 2, wherein said powerline-signal coupling unit is a coupling transformer.

5. An apparatus for providing power and network signal from a powerline network according to claim 2, wherein said network communication module comprises:
a powerline-signal coupling unit electrically connected to said power component;
a signal processing unit electrically connected to said powerline-signal coupling unit, to access and process said network signal;
an Ethernet transformer electrically connected to said connecting port; and
an Ethernet access unit electrically connected to said signal processing unit and said Ethernet transformer, to receive said network signal and transmit said network signal to said connecting port through said Ethernet transformer, and to receive an apparatus signal from said connecting port and transmit said apparatus signal through said Ethernet transformer to said signal processing unit.

6. An apparatus for providing power and network signal from a powerline network according to claim 5, wherein said power over Ethernet module comprises a power over Ethernet unit, which electrically connects to said power unit and said connecting port, to transform said power from said power unit into said network power and then to transmit said network power to said connecting port.

7. An apparatus for providing power and network signal from a powerline network according to claim 5, wherein said powerline-signal coupling unit is a coupling transformer.

8. An apparatus for providing power and network signal from a powerline network according to claim 1, further comprising a shell which integrates and contains said power unit, said connecting port, said power over Ethernet module and said network communication module.

9. An apparatus for providing power and network signal from a powerline network according to claim 1, wherein said power component is a power cord with a plug on one end of said power cord, and said plug is put into a socket to electrically connect to said powerline network.

10. An apparatus for providing power and network signal from a powerline network according to claim 1, wherein said power component is an electric plug which is put into a socket to electrically connect to said powerline network.

11. An apparatus for providing power and network signal from a powerline network according to claim 1, wherein said connecting port is RJ45 port, which comprises a data receiving pair and a data transmitting pair.

12. An apparatus for providing power and network signal from a powerline network according to claim 11, wherein said power over Ethernet module comprises:
a power over Ethernet unit electrically connected to said power unit to obtain said power from said power unit; and
a power over Ethernet transformer electrically connected to said power over Ethernet unit and said network communication module, to provide said network power.

13. An apparatus for providing power and network signal from a powerline network according to claim 11, wherein said RJ45 further comprise at least one spare pairs.

14. A n apparatus for providing power and network signal from a powerline network according to claim 13, wherein said power over Ethernet module comprises a power over Ethernet unit electrically connected to said power unit and said RJ45 port, to transform said power from said power unit into said network power which is then transmitted by said spare pairs of said RJ45 port.

15. An apparatus for providing power and network signal from a powerline network according to claim 1, wherein said network power is direct voltage.

16. An apparatus for providing power and network signal from a powerline network according to claim 1, wherein said connecting port is any connector which comprises a data receiving pair, a data transmitting pair and direct voltage.
